(19) United States
(12) Patent Application Publication
(10) Pub. No.: US 2011/0050855 A1
(43) Pub. Date: Mar. 3, 2011

(54) OPTICAL MEASURING DEVICE WITH TWO CAMERA UNITS

(76) Inventors: Guenter Nobis, Nuertingen (DE); Volker Uffenkamp, Ludwigsburg (DE)

(21) Appl. No.: 12/160,374

(22) PCT Filed: Jul. 2, 2007
(86) PCT No.: PCT/EP07/56618

§ 371 Date: Jul. 9, 2008

(30) Foreign Application Priority Data
Jul. 26, 2006 (DE) 10 2006 035 232.7

(51) Int. Cl. H04N 15/00; G03B 35/00

(52) U.S. Cl. 348/47; 396/325; 348/E15.001

(57) ABSTRACT

The invention relates to an optical measurement device with an image acquisition unit, which has at least two camera units (10) on a holding structure, assigned to each other, using local arrangement and alignment. A stable, low-cost design is obtained by the fact that the holding structure has a one-piece supporting body (1) with mounting structures molded thereon, in which the camera units (10) are accommodated (FIG. 2).

### RELATED ART

The present invention is based on an optical measuring device with an image acquisition unit, which includes at least two camera units assigned to each other on a holding structure, with spatial positioning and alignment.

An optical measuring device of this type may be used for various measurement tasks, e.g., for measuring the ground drive of motor vehicles, as described in DE 197 51 763 A1 and DE 197 57 760 A1, in conjunction with three-dimensional (3D) image measuring to technology.

3D image measuring technology typically uses image measuring units that include image acquisition units with two or more cameras. To perform a precise 3D measurement, it is necessary to ascertain how the cameras are positioned relative to each other by using a calibration procedure, and to provide this information to the measuring system with each measurement. In practical application, it is crucial to the accuracy of the 3D measurement that the position of the cameras relative to each other remain stable for the longest period of time possible, even when temperatures fluctuate and under mechanical loads. When designing image measuring units, it is entirely common to attach complete cameras to a supporting structure, e.g., a special support tube, using stable, play-free, detachable connections. Other design solutions are known (without mentioning publications as evidence), with which the main components of a camera are attached to the supporting structure without the housing that encloses the complete camera. For example, the camera chips, the electronics close to the sensor, and the associated camera lens are attached in a special mounting part. These mounting parts are then attached to the supporting structure, which is composed of several components. Structures of this type are complex in design, expensive, and not adequately stable over the long term, and they require recalibration in the field when used for a moderately long period of time. If a technical expert (e.g., customer service) is required to carry out the required calibration procedure, this often greatly reduces the acceptance of the 3D image measuring technology and results in additional operating costs.

The object of the present invention is to provide an optical measuring device of the type described initially that results in a robust design that is stable over the long term, that may be installed simply and precisely, and is cost-favorable.

### DISCLOSURE OF THE INVENTION

### Advantages of the Invention

This object is achieved via the features of Claim 1. It is provided that the holding structure includes a one-piece supporting body with mounting structures molded thereon, in which the main components of a camera are accommodated. The main components of a camera—the camera chip, electronics close to the sensor, and optical attachment elements—are referred to below as the camera unit.

The one-piece supporting body with the mounting structures results in an unequivocal is assignment of the camera units to each other and a robust design with a high level of mechanical and thermal stability.

The installation and unequivocal assignment of the camera units to each other are simplified by the fact that the mounting structures all have the same design, to accommodate identical camera units.

In a design that is advantageous in terms of the configuration in a measuring device, the supporting body has a longitudinal profiled section that is composed of metal or plastic.

The design is stable due to the fact that the profiled section includes reinforcement ribs that extend longitudinally or transversely.

The design and installation are further simplified by the fact that a further end section is integrally formed on both sides of the longitudinal profiled section in which the mounting structure is formed.

Further advantageous measures, in particular for a stereo measurement, lie in the fact that the mounting structures are designed and oriented such that the optical axes of the at least two camera units accommodated therein extend toward each other in the space in front of the camera units, and they intersect at a point.

In a design that is advantageous in terms of manufacture and installation, the two end sections are bent inwardly toward each other relative to the straight, longitudinal profiled section, forming an obtuse angle.

Installation is simplified and the design is made robust by the fact that at least some of the mounting structures are designed as recesses in the supporting body, and a camera chip and optical attachment elements are placed in the particular recess.

The mode of operation of the measuring device with a precise design is enhanced by the fact that the mounting structures for the camera chips and the optical attachment elements are manufactured in a single machine set-up, thereby making it possible to attain a high level of precision.

The design is advantageous and compact also due to the fact that illumination units are also accommodated in the mounting structures, and sensor electronics are located on the supporting body on the back side of the mounting structures facing away from the camera units.

The particular advantages are realized, e.g., when the optical measuring device as recited in one of the preceding claims is used with a test station for performing optical measurements of the ground drives of motor vehicles.

### BRIEF DESCRIPTION OF THE DRAWING

The present invention is explained in greater detail below using exemplary embodiments, with reference to the drawings.

FIG. 1 is a schematic depiction of an image measuring unit of an optical measuring device,

FIG. 2 is a perspective view of a supporting body for camera units to be used in the image measuring unit,

FIG. 3 shows an end section of the supporting body in FIG. 2 with elements of an image acquisition unit to be installed therein, in a perspective view, and

FIG. 4 is an enlarged, perspective view of an end section of the supporting body in FIG. 2.

### EMBODIMENT OF THE INVENTION

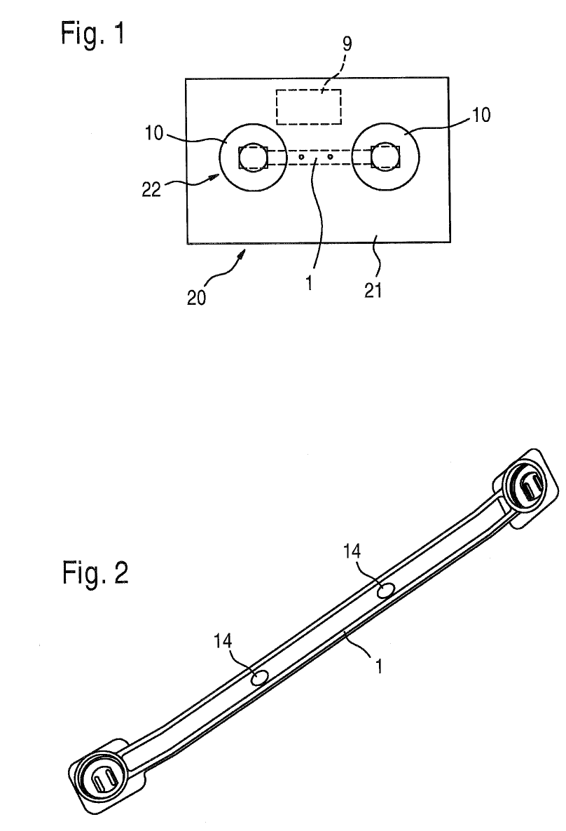

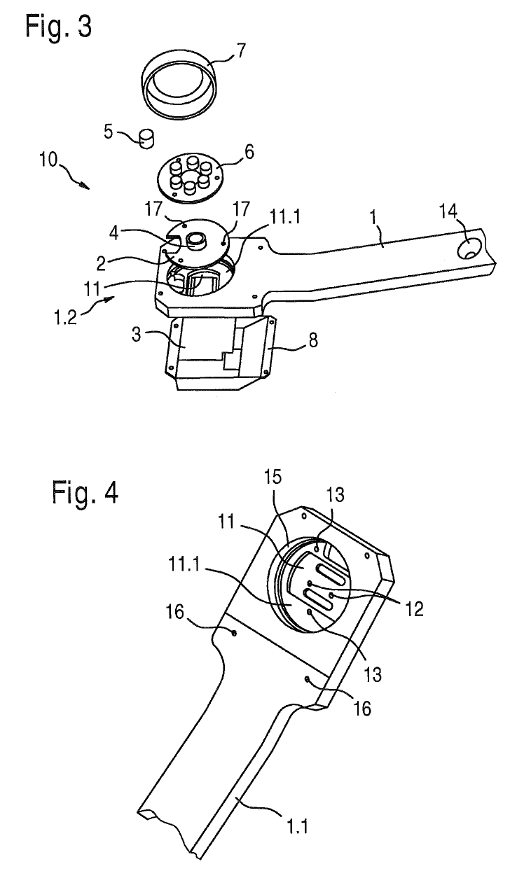

FIG. 1 shows an image measuring unit 20, with which two camera units 10 are located in a housing 21 in the region of optical housing openings 22, which are accommodated on a supporting body 1 installed in the housing. An electrical circuit to module 9 for operating the two camera units 10, and, possibly, an illumination device, e.g., with illumination units 6 as shown in FIG. 3, are also located in housing 21.

As shown in FIG. 2, supporting body 1 is designed as a single piece, and is composed, in the center, of a longitudinally extending profiled section 1.1 that is reinforced with longitudinal ribs, and has, e.g., a U-shaped or double T-shaped cross is section. Profiled section 1.1, which extends, e.g., in a straight line, includes fastening elements 14 in housing 21 or a similar supporting structure, e.g., through-holes or pegs or the like, and transitions at its ends and as a single piece into end regions that are bent inward at identical, obtuse angles, the end regions expanding to form end sections 1.2. Mounting structures for the elements of camera units 10 and illumination units 6 and, possibly, further components are formed in expanded end sections 1.2. The mounting structures may be located on both sides of expanded end section 1.2 and possibly in regions adjacent thereto, e.g., with the optical elements and their supporting elements installed on one side, and the electronic elements and their carrier installed on the other side. This results in a compact design of the components of particular camera unit 10 and its assigned electronic elements that interact in an optical, mechanical, and electronic manner that may be installed in a simple, defined manner, with exact positioning and orientation relative to each other.

With the exemplary embodiment shown in FIG. 3 for the components of camera unit 10 and illumination unit 6 to be placed in expanded end section 1.2 of supporting body 1 on one side, and associated sensor electronics 3 on the other side, the following are placed at least partially in a recess in expanded end section 1.2, in succession on a mounting surface 11 of the mounting structure: A camera chip 2 and a lens 5 to be placed in a lens holder 4 on a parallel mounting surface 11.1, an illumination unit 6 with light-emitting diodes located in an annular pattern on a carrier around lens 5, and protective glass 7. Suitable holding elements and/or fastening elements, e.g., with fastening holes 17, are used, if necessary. Sensor electronics 3, which are covered with a cap 8, are installed on the side of end section 1.2 facing away from camera unit 10, opposite to camera chip 2. As an alternative, camera chip 2 may be mounted, e.g., on a carrier of sensor electronics 3, it may be fixed in position on the mounting structure on the same side as sensor electronics 3, and it may be connected optically with the further elements of camera unit 10 on the opposite side through an opening. As also shown in FIG. 4 in particular, receiving elements 12 and assembly elements 13 such as is mounting surfaces, holes, projections, and/or openings are also provided in the supporting structure. In the exemplary embodiment shown, camera chip 2 is contacted with sensor electronics 3 via openings, through which the connecting elements are guided. Further fastening elements 16 in the form of holes or pegs are also provided on expanded end section 1.2 for attaching cap 8. Further fastening elements, e.g., a thread for accommodating a counter-thread, or recesses or projections for snapping counter-elements into place are provided on the circumferential edge of the recess of the supporting structure for attachment of protective glass 7 and/or any optical filters to be used.

Supporting body 1, which is designed as a one-piece carrier, is composed of a profile that is torsionally stiff and rigid, that is dimensionally stable even under the influence of temperature, and that may be manufactured, advantageously, simply by shaping a crude part. Mounting surfaces 11 are provided in end sections 1.2 at a defined angle for camera chips 2 and lens holder 4, which are processed mechanically in a single set-up. The positioning of camera units 10 relative to each other is therefore established mechanically, with their optical axes preferably pointing toward each other and intersecting at a point in the space in front of camera units 10 and/or measuring unit 20.

In this manner, a stereo measuring bar is formed with supporting body 1 and camera units 10. Positioning aids for ensuring that camera chips 2 are attached to supporting body 1 in a precise and simple manner, e.g., via bonding, are provided on mounting surface 11 for camera chip 2. These positioning aids may be designed, e.g., as contact surfaces for camera chip 2, or as positioning pins (e.g., as in the chip-manufacturing process). The holding structure with supporting body 1 is advantageously designed such that sensor electronics 3 with a small electronics printed circuit board are bonded to the back side of mounting surface 11 of camera chip 2 after installation on the particular mounting structure of end section 1.2. This results in dust and moisture protection for camera chip 2 and lens 5 on the back side. After camera chip 2 and sensor electronics 3 are mounted on supporting body 1, camera chip 2 is soldered together with sensor electronics 3.

A further mounting surface 11.1 for lens holder 4 is provided in parallel with mounting surface 11 for camera chip 2. The particular mounting surface and lens holder 4 include a circular collar for the simple yet precise orientation of lens 5 relative to the main point of camera chip 2. This collar may extend around the entire circular circumference, or only along individual circular segments. Lens holder 4 is installed by screwing it onto the particular mounting surface, with the aforementioned collar ensuring that it is centered. The mounting surface may be designed as a three-point contact surface for lens holder 4 to simplify the fine-tuning of the installation. All of the processing steps that are relevant for the precise alignment of the two camera chips 2 and associated lens 5 are preferably carried out in a single set-up of supporting body 1 and/or stereo measuring bar.

In addition, mounting elements for illumination unit 6 with the annular LED illumination are provided in the mounting region of lens holder 4. Illumination unit 6 is composed of several light-emitting diodes that are soldered to a printed circuit board, and it is designed such that the light-emitting diodes are located concentrically with lens 5. An opening is provided in supporting body 1 and lens holder 4 for the installation of the connecting cable between illumination unit 6 and the printed circuit board of electrical circuit module 9. As an alternative, fastening elements 17 for illumination units 6 may also be provided in lens holder 4.

In addition, a fastening thread for an optical filter or a protective disk 7 for the simultaneous protection of lens 5 and illumination unit 6 is provided concentrically to lens holder 4. This thread is designed such that common commercial protective glasses 7 or filters may be used for standard lenses. Dust and moisture protection for lens 5, illumination unit 6, and camera chip 2 is therefore provided in a simple manner.

Supporting body 1 includes, in its center region, a fixed bearing and a floating bearing, which are provided for installation in housing 21 of imaging measuring unit 20.

Lens 5 is mounted in lens holder 4 via a centrally located thread. It is therefore provided that the lens may be adjusted in a finely-tuned manner relative to camera chip 2, to ensure that a sharp image is obtained after lens holder 4 is installed. After the finely-tuned adjustment, lens 5 is bonded with lens holder 4, or it is locked in position mechanically.

The design of housing 21 of image measuring unit 20 is kept very simple. It includes the is counter-pieces for the floating bearing and fixed bearing of supporting body 1, a receptacle for the printed circuit board, and the plug connector of image measuring unit 20, mountable housing parts for covering the front of image measuring unit 20, and fastening elements for the complete image measuring unit 20.

As an alternative to the basic design described above, with the direct attachment of camera chips 2 on supporting body 1 and/or stereo measuring bar, and the installation of lens 5 via lens holder 4, it is also possible to provide a basic design that includes the direct attachment of lens 5 to the mounting structure of supporting body 1 and installation of camera chips 2 via a camera chip carrier, on which sensor electronics 3 are also mounted.

What is claimed is:

1. An optical measuring device with an image acquisition unit, which includes at least two camera units (10) assigned to each other on a holding structure, with spatial positioning and alignment,
wherein
the holding structure includes a one-piece supporting body (1) with mounting structures molded thereon, in which the camera units (10) are accommodated.

2. The measuring device as recited in claim 1,
wherein
the mounting structures all have the same design, to accommodate identical camera units (10).

3. The measuring device as recited in claim 1,
wherein
the supporting body (1) has a longitudinal profiled section.

4. The measuring device as recited in claim 3,
wherein
the profiled section is provided with longitudinally extending reinforcing ribs.

5. The measuring device as recited in claim 3,
wherein
a further end section (1.2) is integrally formed on both sides of longitudinal profiled section (1.1), in which the mounting structure is formed.

6. The measuring device as recited in claim 1,
wherein
the mounting structures are designed and oriented such that the optical axes of the at least two camera units (10) accommodated therein extend toward each other in the space in front of the camera units and intersect at a point.

7. The measuring device as recited in claim 5,
wherein
the end sections (1.2) on either side are bent inwardly toward each other relative to the straight, longitudinal profiled section (1.1), forming an obtuse angle.

8. The measuring device as recited in claim 1,
wherein
the mounting structures are designed as recesses in the supporting body (1), and a camera chip (2) and optical attachment elements are placed in the particular recess.

9. The measuring device as recited in claim 1,
wherein
the mounting structures for the camera chip (2) and optical attachment elements are located such that their ends may processed using a single machine set-up.

10. The measuring device as recited in claim 1,
wherein
illumination units (6) are also accommodated in the mounting structures.

11. The measuring device as recited in claim 1,
wherein
sensor electronics (3) are located on the supporting body (1), on the back side of the mounting structures facing away from the camera units (10).

12. The use of the optical measuring device as recited in claim 1 with a test station for performing optical measurements of the ground drives of motor vehicles.
